(19) United States
(12) Patent Application Publication
(10) Pub. No.: US 2006/0162940 A1
(43) Pub. Date: Jul. 27, 2006

(54) Fire extinguisher

(76) Inventor: Carl Pohler, Solingen (DE)

Correspondence Address: HENRY M FEIEREISEN, LLC, 350 FIFTH AVENUE, SUITE 4714, NEW YORK, NY, 10118, US

(21) Appl. No.: 10/530,928

(22) PCT Filed: Oct. 9, 2003
(86) PCT No.: PCT/EP03/11161

§ 371 Date: Apr. 11, 2005

(30) Foreign Application Priority Data
Oct. 9, 2002 (DE) 102 47 158.4

(51) Int. Cl. A62C 25/00

(52) U.S. Cl. 169/53; 239/171

(57) ABSTRACT

The invention relates to a fire extinguisher comprising a container for extinguishing fluid and an internal bag used as a retainer of a blasting charge.

The invention relates to a device and a method for extinguishing, especially for extinguishing of forest fires.

It is known that water-aerosol-mist has a specially good extinguishing efficiency. This is partly because the heart of the fire is suffocated due to the aerosol-mist. Furthermore, heat is drawn from the fire by the evaporation of the water that is present as specially fine mist. From WO 97/06858 A1 it is known, to transport a blasting bag filled with water with a helicopter and to drop it over a fire. With the blasting bag dropping free, a blasting charge inside the bag will be detonated. Through the pressures thus created, the blasting bag is destroyed and the water situated therein is suddenly transformed into a aerosol-mist. For security reasons, this known method has not pulled through in constant praxis.

From this starting point it is an objective of the invention, to further enhance the known extinguishing method and the components used therefore in such a manner that they can be used safely.

This objective is solved by the object of the independent claims. Preferred embodiments of the invention are mentioned in the dependent claims.

According to the invention, the proposed extinguishing device has a container for an extinguishing fluid and an inner bag as holding-device for a blasting charge. The use of an inner bag as a keeping device for a blasting charge has the advantage that the blasting charge can be held separately from the extinguishing fluid and treated separately. Thus the influence of the extinguishing fluid on the blasting charge can be avoided on the one side. On the other side, the blasting charge can be brought into the position desired for the blasting in an easy manner after the container has been filled.

As container, every body is suitable that can hold extinguishing fluid and that can be at least partially destroyed through the detonation of a blasting charge, to set the extinguishing fluid free in form of an aerosol. Preferably, the container is made of water tight material.

The blasting charge can contain any type of explosive that is in an appropriate quantity able to produce a pressure-wave after detonation that transforms the extinguishing-fluid into an aerosol-mist. TNT is especially preferred as explosive. Per container, different types of explosive can be foreseen at the same time, especially in order to influence the form and/or propagation of the aerosol-mist, especially in a given geometric arrangement.

An extinguishing fluid in the terms of the invention is any fluid that can be transformed into an aerosol by means of a pressure-wave. Water is a preferred extinguishing-fluid. Furthermore, mixtures of water and special additives are preferred. These additives can for example be foam creator or for example other, flame suffocating agents or agents that hinder a flair up or new ignition.

The inner bag is preferably made flexible and especially at least partially produced from a textile. As an alternative, the inner bag can be made from plastic, especially by means of a stiff plastic body, especially plastic tubes. The plastic tubes can preferably be screwed together at their ends.

The inner bag is preferably perforated with wholes. In this manner, the explosive is partially in direct contact with the fluid. This enables a good propagation of the pressure wave, which leads to an efficient misting of the fluid.

To reduce the production efforts for the containers, these are preferably produced in standard sizes, especially in sizes for 25 to 50 kg, 250 kg, 500 to 1000 kg and 1000 to 5000 kg of extinguishing fluid. Sizes above 5000 kg of extinguishing fluid can also be produced. About 25 to 50 kg extinguishing fluid is used for small size fires beginning with camp side fire sizes, about 250 kg extinguishing fluid is used by area fires up to 100 square meters, about 500 to 1000 kg extinguishing fluid is used with area fires larger than 100 square meters and about a 1000 to 5000 kg extinguishing fluid is used with large fires.

The blasting charge can be held with the holding device within the extinguishing fluid, especially where a specially even transformation of the extinguishing fluid into an aerosol is to be achieved. Especially good results where achieved, when the blasting charge was held in the centre of mass of the filled, free falling container. It can, however, be preferable, to arrange the blasting charge outside the centre of mass.

In a specially cheep manner, the container can be made from a textile, whereby the textile can be any woven, knitted material or material made in any other fashion from fibres or strings. Preferably the textile is either woven in such a way, that it is water tight, or made water tight by impregnation. Preferably the container can also be made in a different fashion, for example as one piece from plastics. Especially preferred, the container is water tight.

In a preferred embodiment, the container has an inner container that immediately surrounds and holds the extinguishing fluid. This allows for the advantage that the inner container can be designed especially for holding the water fluid, for example especially water tight, while separate there from, the container can be designed according to requirements that are pre-given through the transport, for example especially tear-resistant in the direction of load, for example in the lifting direction. Preferably, the inner container is tightly connected with the container, for example by means of bonding. In a further preferred embodiment, the inner container has separate layers. Especially preferred, the inner container has three layers and consists of three contour bags. The outer of these contour bags is bonded to the inner side of the container, preferably at certain dots, and is of the type of an inner coating of the container. The contour bag immediately adjacent thereto on the inner side operates as additional tightening- and gliding layer for the inner most contour bag.

In addition or as alternative, the container and/or the inner container can have an inner coating. This coating can serve to make the container or the inner container, respectively, water tight. The coating is preferably persistently elastic.

Preferably, the container and/or the inner container are made of a biologically degradable material. By means of the explosion the container and, if present, the inner container are destroyed and are left at the site of use. Since due to the high efficiency of the aerosol-mist it cannot be guaranteed, that the remainder of the container and/or the inner container are burned through the fire, it is advantageous for the environmentally correct use of the extinguishing device according to the invention, if these are made from biologically degradable material. In an especially preferred embodiment, the occurring remainders of the container and/or the inner container are not harmful for animals, if they are taken up as food or with the food.

Since for extinguishing the container is preferably transported by means of a aeronautical vehicle to the heart of the fire and is dropped there, it is advantageous if the container has an aerodynamically favourable shape in an preferred embodiment. Especially, the container has the form of a drop, at least when it has been dropped above the heart of the fire and is in free flight. Alternatively, the container or the inner container respectively can be designed as a sphere, a cuboid or a roller, in order to fulfil the requirements of an even propagation of the aerosol-mist or the compactness combined with high transport quantities.

In order to facilitate the transport of the container in air and to easily align the container into the desired position for the drop and in order to give the container a predetermined flight path after the drop, the container can in a preferred embodiment have elements on its outside, especially preferred flight stabilizing elements. These can for example be wings, tales or breaking parachutes.

In order to be handled easily during a transport, the container can, in a preferred embodiment, have gripping-loops for gripping elements of a transport device. As gripping-loops any type of form is understood, that can be used with accordingly designed gripping elements, in order to move the container, especially in order to lift the container. Especially preferred, the gripping-loops are hanging-loops, loops, hooks or rings. Gripping pockets can, as an example, be provided.

Any device is understood as a transporting device that can transport the container. This device can be a roll-wagon, in which the container is inserted, or for example a crane. Especially preferred as a transporting device is however an aeronautical vehicle, whereby according to the understanding of this invention an aeronautical vehicle contains any flying means, especially aeroplanes, helicopters or balloons.

If a container is used, that is shaped as a peak on one side, the gripping loops are preferably positioned at this end. The gripping loop is especially preferred a attachment-tape or string, that is worked into the container wall, especially into a textile wall.

In an especially preferred embodiment of the invention, the container has a filling opening for filling in the extinguishing fluid at its top. This opening allows for an easy filling of the container. Especially preferred, this opening of the container is made such, that a container made as a bag can be put into a filling holder, that can for example be made of cylindrical form, and can with parts of the outer wall surrounding the opening be laid over the bordering walls of the filling holder. In this manner, a bag shaped container can be held in good fashion in the filling holder. Alternatively, for example with containers that have a peak, a filling opening can be foreseen at the side, especially in the area of the peak.

Preferably the opening in the container, the inner container and/or the inner bag respectively can be closed by means of an attachment tape or a string, by means of pulling together the string worked into the container wall, preferably into the wall of a textile container, and thereby closing the opening. Preferably, the attachment tape can be designed on the inner wall of the opening. Thereby, it is protected against damage and does not hinder the handling of the container. As attachment tape, binder (cable binder) can be used.

Alternatively or in addition, the opening in the container, the inner bag and/or especially the inner container can be closed by means of welding. In this fashion, an especially water tight closing is achieved.

The opening foreseen for filling the container, the inner container, or the inner bag respectively can have an finishing piece, especially a filling nozzle, that aids the filling, which is preferably attached in an detachable manner to the container, or can be inserted into the opening. Especially, the filling nozzle can be made detachable.

Where a container with an inner container is used, the openings of the container and the inner container can preferably be aligned with each other. The bordering edges of the openings are preferably connected to each other, for example bonded together.

Especially with a container that has a peak on one side and an inner container, but also in other arrangements, the inner container can preferably have a form with a peak on one side and is filled through this peak, whereby the peak can be taken through an opening at the side of the peak of the container. After filling, the opening of the inner container can be closed, for example by means of strings provided at the opening, and can be connected into the peak of the container from the inside. For this, the opening arranged at the side of the container can be reached through and the peak of the inner container can be connected with the inside of the peak of the container.

Preferably, the inner bag is adjustable in its length, for example strings connected to the edges of the inner bag, for example connected to the bottom of the inner bag or the lower wall regions of the bag can be arranged for. By means of pulling in the strings, the inner bag can be shortened. In this manner, the inner bag can be arranged in such a manner within the container, that the blasting charge arranged in the inner bag can be held in the desired position, for example in the centre of mass of the container. By means of changing the length of the inner bag, for example by changing the length of the string, the inner bag can also be lengthened and shortened in such a way, that the blasting charge can be held above or below the centre of mass, if this is desired.

Preferably the inner bag is designed as an elongated hose, closed at one end, with an opening aligned with the opening of the container or the inner container respectively. Such an arrangement allows the inner bag to be filled with the blasting charge from the outside, when the container or the inner container respectively are already filled.

Alternatively or in addition, the inner bag can be connected with the container or the inner container respectively by means of strings. The strings connected to the upper areas of the inner bag are preferably connected with their other ends to the container or the inner container respectively in the area of the opening of the container or the inner container, respectively. Then also, the inner bag can be easily filled, by means of pulling it up with the strings, until the opening of the inner bag is in the area of the opening of the container or the inner container respectively.

Preferably, the inner bag has a filling end, that has a opening for filling the inner bag with the blasting charge, that can preferably be closed, and a closed, opposite end. Preferably, the closed end is connected to the inner side of the container or the inner container, respectively, by means of a string. For this, the container or inner container, respectively, can, at a suitable position, have a button, preferably a mushroom shaped button, onto which the string can be connected. Especially preferred, the container or the inner container respectively has a further closable opening in the area of the button that allows the string of the inner bag to be easily connected to the container or the inner container, respectively. Alternatively, the string can be fixedly connected to the container or the inner container, respectively, for example welded to it.

In addition or alternatively, strings can be foreseen, that connect to the inner bag at the side. These strings are preferably connected to the sides of the inner container or the container, respectively, and can be used to improve the positioning of the inner bag.

The fixings of the inner container, especially the strings provided at the closed end, but also the strings for hanging up the inner container, are preferably made elastic.

In order to facilitate the insertion of the detonation cable for the blasting charge from the outside, at the time when the blasting charge is inserted into the inner bag, the detonator and the detonation cable end connected to the detonator are preferably already connected to the blasting charge when the blasting charge in inserted into the inner bag.

A closure for the container or the inner container preferably has means for leading through of the detonation cable for example a leading through plug. When closing the inner container, this plug can be inserted into the thus closed opening by means of welding.

Preferably a reflector is arranged on the outside of the container. This reflector allows for controlling of the flight path/position of the container, for example by means of a laser tracker. This reflector is preferably designed as a foil. In a specially preferred manner, a receiver is connected with the foil, which is connected to the container through the foil. This receiver can be designed in such a way, that it can receive and analyse sent signals, for example light signals or radio-frequency signals or the like. In this manner, influence can be put on the detonator, for example the detonation time can be changed.

The method according to the invention, a container is filled with an extinguishing fluid, a blasting charge is inserted into an inner bag arranged in the container and a pressure wave is created by means of detonating the blasting charge in order to transform the fluid into an aerosol-mist. By means of separately filling the inner bag with the blasting charge and the container with the extinguishing fluid, blasting charge and extinguishing fluid can be handled separately from each other. Hereby, influences of the extinguishing fluid on the blasting charge can be avoided. Especially preferred, a container in the sense of the description of the method according to the invention can also be an inner container as described above. The method can be accomplished, by means of filling the container with extinguishing fluid first and then inserting the blasting charge into the inner bag. These method steps can, however, also be conducted in changed order.

Especially preferred, the blasting charge is detonated in a container dropped above the heart of the fire and filled with extinguishing fluid, at the time when the container is in a predetermined height over the heart of the fire. The necessary height can without a problem be determined by means of field experiments. The height is among others dependent on the relative, geographic position of the container in relation to the heart of the fire, the form of the ground (flat or hilly), the direction of the wind and the strength of the wind, the quantity of extinguishing fluid and the blasting charge.

In order to warn people in the area of the fire of the explosion, it is sensible to give a warning prior to detonation of the blasting charge, for example a sound signal or a light signal.

In order to fight a larger fire or a fire front, it is sensible to detonate blasting charges in several containers with extinguishing fluid, especially if these are detonated set offset to each other. Especially where an airplane is used to transport the container, it is advantageous, to drop the containers one after the other out of the airplane and to detonate one after the other. In this fashion, a corridor can be created within the fire.

Especially preferred, the detonation timing is determined by means of a calculation unit based on at least one or in combination of the following influencing factors: Geographic coordinates, height of flight, result of an infrared-measurement, velocity over ground, direction of wind, strength of wind, outside temperature, distance to other places, where the extinguishing method is used, desired height of the detonation point over ground. For this, the calculation unit compares the measured influence factors with values that are stored in a table.

Especially preferred, the calculation unit has a data management system, in which the used set up and the influences can be stored for each single blasting charge. For this, each blasting charge has an identification number, under which identification number the used set up and influences are stored. Especially data can be stored under each identification number, which data represents the flight path taken by the container with the identified blasting charge. This data can be used to control and adapt the assumptions used for the calculation of the detonation timing and the drop timing. The allocation of single identification numbers to each single blasting charge furthermore allows for blasting charges to be addressed specifically. For example, with already dropped containers, each detonation timing of each of the dropped containers can be altered by use of radio-frequency signals. The radio-frequency signal can for example enclose the identification number, in such a way that on the side of the receiver, for example a receiver arranged in a container, the information received with the radio-frequency signal is only transmitted to the detonator, if the identification number is equal to the one of the blasting charge.

A control unit for an aeronautical vehicle according to the invention has an adapter for connecting the control unit to the aeronautical vehicle and has at least one of the following elements: Heat picture sensor, ground distance radar, video camera, especially for 360°-inspection and protocolling, long distance data transmission units, communication-relay stations, especially for communication between the people engaged in the fire fighting, and synchronisation units, for synchronising of aeronautical vehicles flying in a special formation. Such a control unit can in an easy fashion, namely by means of the matching adapter—be connected to a standard airplane, helicopter, balloon or the like.

In an preferred embodiment, the control unit has a laser tracker. This laser tracker allows for control of the position of the container. Especially the laser tracker scans the area below the aeronautical vehicle. Even if the method is conducted with several containers, such a laser tracker can control the position of the respective containers. This is especially desired, after the container has been dropped, in order to find out, whether the containers have reached their desired position. Furthermore, protocolling of the flight path of each dropped container allows for conclusions to be drawn about the surrounding conditions. This information can be used and accounted for in further drops.

The control unit is preferably used for the above-mentioned method according to the invention. Thus a device is created for gaining the necessary data in order to determine the detonation timing, which in an easy fashion can be connected to the above-mentioned airplanes etc. Thus an aeronautical vehicle can be quickly equipped for an extinguishing mission.

Preferably the control unit has communication means for communication with the detonator. These communication means can be a known cable connection. Especially preferred, these means are emitters for radio-frequency signals or the like, like for example blue-tooth emitting-units.

In especially preferred embodiment, the outer form of the control unit is in accordance to a protective shield protecting the aeronautical vehicle from an extinguishing device as described above hanging from the aeronautical vehicle. In this manner it is prevented that detonation of the blasting charge in the surroundings of the aeronautical vehicle leads to damage of the aeronautical vehicle.

Likewise, the protective device for an aeronautical vehicle is proposed according to the invention, which has a protective shield, that protects the aeronautical vehicle from an extinguishing device as described above, that is hanging from the aeronautical vehicle. Also when conducting the above-mentioned method without means for data collection in a control unit, it is advantageous, to protect the aeronautical vehicle for damages through the explosion.

The protective shield preferably has a discus-shape.

Preferably the aeronautical vehicle and—if used—the above described control unit are connected with the above described extinguishing device to build a extinguishing system. For this, the container is picked up by the aeronautical vehicle by means of a remote-hook. This remote-hook preferably contains of several component-sections, which by means of dividing up in intermediate sections do not relay the vertical forces caused to the aeronautical vehicle. This allows the detonation to take place, even if the container is hanging from the remote-hook.

The device according to the invention and the method according to the invention can especially be used for extinguishing forest fires, for extinguishing fires on oil-platforms or for rescuing forest workers that are closed in.

Below, the invention will be described by means of a drawing showing examples. In this drawing:

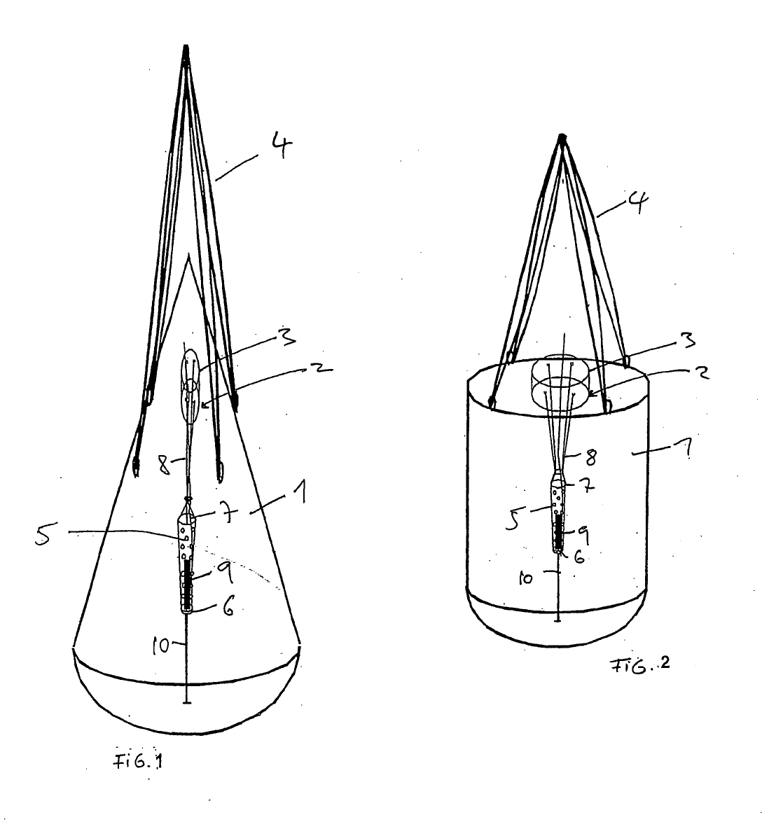

FIG. 1 to 4 shows embodiments of the extinguishing device according to the invention,

FIG. 5 shows a detail of the extinguishing device according to the invention and

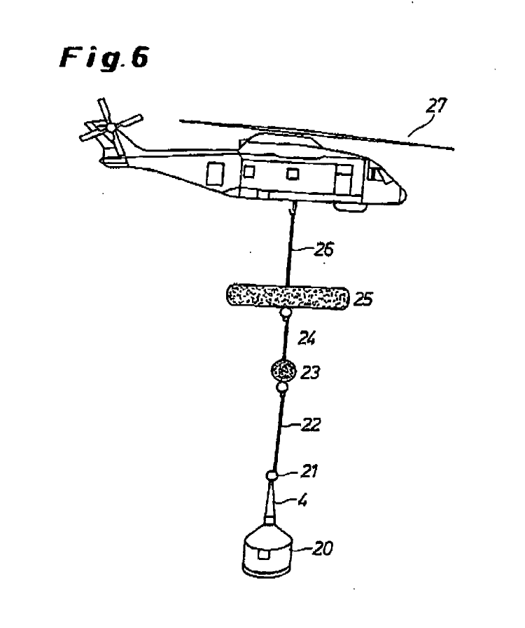

FIG. 6 shows an extinguishing system according to the invention.

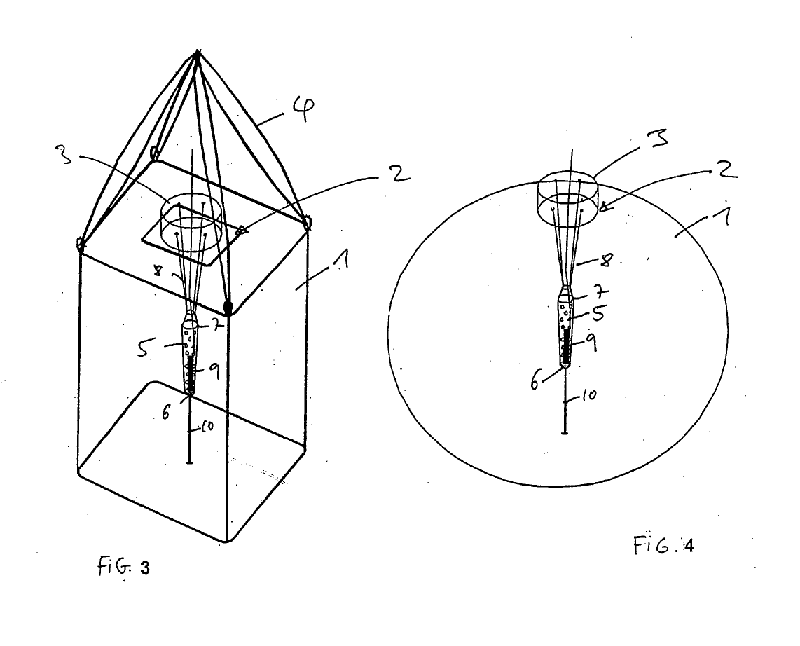

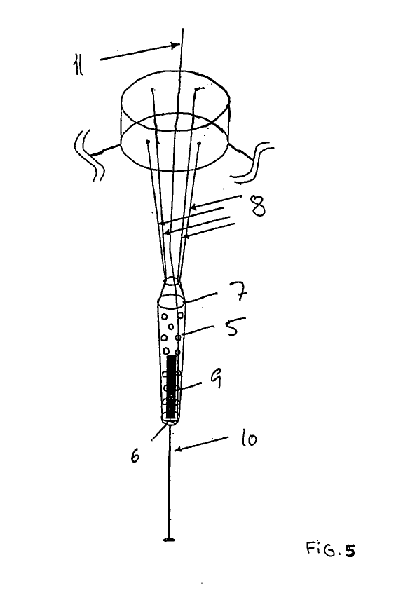

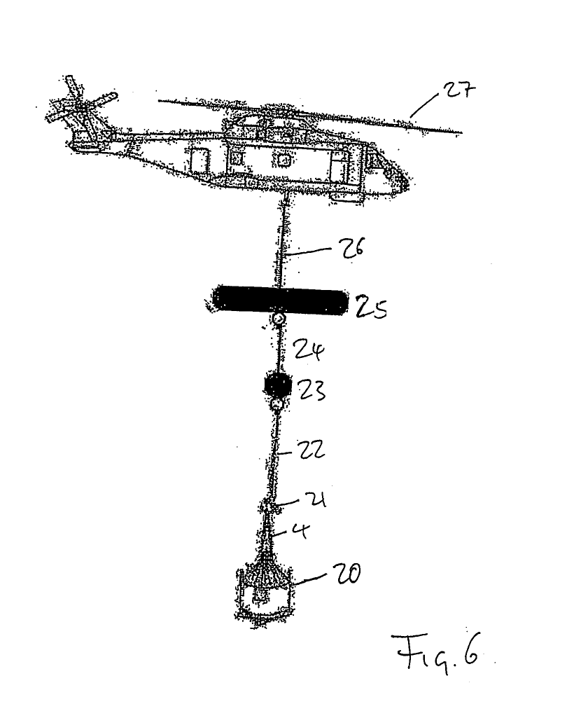

By using the same reference numbers for like elements, FIG. 1 to 4 show a container 1 of the extinguishing device according to the invention. In FIG. 1 this container has a form of a drop, in FIG. 2 the form of a roller, in FIG. 3 the form of a cuboid, and in FIG. 4 the form of a sphere. Within the container 1 there is an inner container not represented in more detail, which is filled with extinguishing fluid. Of the inner container an end 3, reaching out of the opening 2 of the container 1 (filling nozzle) can be seen. This end 3 is used for closing the inner container, after the inner container has been filled with extinguishing fluid, for example by means of welding, whereby the over standing parts are cut off. Carrying strings 4 as gripping loops are arranged on the container 1. By means of the carrying strings 4 the container 1 can be transported by means of an aeronautical vehicle, for example a helicopter.

Inside of the container 1, a net-shaped inner bag 5 is arranged. This has a closed end 6 and an end 7 with an opening. At the end 7 with the opening, holding strings 8 are arranged, by means of which the inner bag 5 can be connected to the end 3 of the inner container that is reaching out of the opening 2. Therefore the inner bag 5 is arranged in the inner container in a hanging position. By means of the length of the holding strings 8 the position of the inner bag 5 can be influenced. Within the inner bag 5, a blasting charge 9 is arranged. For a better positioning of the blasting charge inside the inner container, the inner bag has a string 10. This is connected to the inner bag 5 at the closed end 6 of the inner bag 5. At the other end, the string 10 is connected to the inner container, especially preferred by means of welding.

As can be seen from FIG. 5, a detonation cable 11 is connected to the blasting charge 9. This is guided out of the opening 2 and out of the end 3 of the inner container reaching out of the opening 2 and led to an detonation unit not shown.

The extinguishing system as shown in FIG. 6 has the extinguishing device 20 according to the invention, a transport element 4 connected to a hook 21 and a holding rope 22, that is connected to an aid-weight 23. Furthermore, the aid-weight 23 is connected by means of a holding rope 24 with an protective shield 25. The protective shield 25 is connected by means of a holding rope 26 with a helicopter 27. Within the protective shield 25, a heat image sensor, a ground distance radar, a video camera, a long distance data transfer unit, a communication-relay station and a laser tracker are arranged.

1. An extinguishing device, comprising:
a container having an interior for accommodating an extinguishing fluid: and
an inner bag arranged in the container to provide a holding device for a blasting charge.

2. The extinguishing device according to claim 1, wherein the container has a container wall which is made of textile.

3. The extinguishing device according to claim 1, wherein the container includes an inner container receptacle which encloses the extinguishing fluid.

4. The extinguishing device according to claim 3, wherein at least one of the container and the inner receptacle has an inner coating.

5. The extinguishing device according to claim 1, wherein the container is configured to exhibit an aerodynamic shape.

6. The extinguishing device according to claim 5, wherein the container has a drop shaped configuration.

7. The extinguishing device according to claim 1, wherein the container is constructed to include flight-stabilizing elements.

8. The extinguishing device according to claim 1, further comprising gripping-loops attached to the container for engagement of a gripping element of a transport device,

9. The extinguishing device according to claim 1, wherein the container has a top formed with a fill-opening for introduction of the extinguishing fluid.

10. The extinguishing device according to claim 1, wherein the inner bag has an opening, which is connected to an opening of the container in such a way, that the inner bag can be filled from outside.

11. The extinguishing device according to claim 1, the inner bag is constructed to be adjustable in size and length.

12. A control unit for an aeronautical vehicle, comprising an adapter for connecting the control unit to an aeronautical vehicle, said control unit being constructed to accommodate at least one element selected from the group consisting of heat image sensor, ground distance radar, video camera, long-distance data transmission unit, communications-relays-station, and laser tracker.

13. The control unit according to claim 12, having an outer form to provide a protective shield for protecting the aeronautical vehicle from an extinguishing device according to claim 1.

14. A protective device for an aeronautical vehicle, comprising a protective shield to protect an aeronautical vehicle from an extinguishing device according to claim 1, that is hanging from the aeronautical vehicle, said protective shield being positioned between the aeronautical vehicle and the extinguishing device.

15. An extinguishing system, comprising an aeronautical vehicle and an extinguishing device according to claim 1 connected to the aeronautical vehicle in a detachable manner.

16. The extinguishing system according to claim 15, further comprising a control unit including an adapter for connecting the control unit to the aeronautical vehicle, said control unit being constructed to accommodate at least one element selected from the group consisting of heat image sensor, ground distance radar, video camera, long-distance data transmission unit, communications-relays-station, and laser tracker.

17. A method of extinguishing a fire, comprising the steps of:
filling a container with extinguishing fluid,
inserting a blasting charge into an inner bag arranged within the container, and
detonating the blasting charge to thereby trigger a pressure wave for transforming the extinguishing fluid into an aerosol-mist.

18. The method according to claim 17, wherein the detonating step is executed when the container is dropped above the source of fire from a predetermined height.

19. The method according to claim 17, further comprising the step of warning ground personnel before the before the detonating step.

20. The method according to claim 17, several of said containers are filled with extinguishing fluid and a blasting charge, further comprising the step of detonating the blasting charge in the containers in a staggered manner.

21. The method according to claim 17, wherein a timing of the detonating step is determined by means of a calculation unit on the basis of at least one influencing factor selected from the group consisting of geographic coordinates, flight height, result of an infrared-measuring, speed above ground, direction of wind, wind force, outside temperature, distance to a site, where the extinguishing method is executed, desired height for the detonation point above ground, and combinations thereof.

22. The extinguishing device according to claim 1, wherein the container is made of water-tight material.

23. The extinguishing device according to claim 1, wherein the inner bag is made of a flexible material selected from the group consisting of textile and plastic.

24. The extinguishing device according to claim 1, wherein the inner bag is perforated.

25. The extinguishing device according to claim 1, wherein the blasting charge in the inner bag is held in the mass centre of the container.

26. The extinguishing device according to claim 3, wherein the receptacle is made of several layers with an outermost layer being bonded to an inside surface of the container.

27. The extinguishing device according to claim 3, wherein the at least one of the receptacle and container is made of biodegradable material.

28. The extinguishing device according to claim 1, wherein the inner bag is constructed in the form of a closed elongated hose having an opening in alignment with an opening of the container.

29. The extinguishing device according to claim 1, wherein the inner bag has strings for attachment to the container.

30. The extinguishing device according to claim 1, further comprising a reflector provided on an outside of the container to allow a checking of a position of the container.
